(19) United States
(12) Patent Application Publication
(10) Pub. No.: US 2024/0180087 A1
(43) Pub. Date: Jun. 6, 2024

(54) AgI DISPERSION FOR CLOUD SOWING AND SOWING TECHNIQUES WITH THIS DISPERSION

(71) Applicant: Manuel Mustieles Ibarra, Ciudad de Mexico (MX)

(72) Inventor: Manuel Mustieles Ibarra, Ciudad de Mexico (MX)

(21) Appl. No.: 18/503,889

(22) Filed: Nov. 7, 2023

(30) Foreign Application Priority Data
Dec. 6, 2022 (MX) MX/A/2022/015518
Jul. 12, 2023 (MX) MX/A/2023/008309

(51) Int. Cl. A01G 15/00; C01G 5/02

(52) U.S. Cl. CPC A01G 15/00; C01G 5/02; C01P 2002/60

(57) ABSTRACT

The invention is related to the chemical products industry on the one hand and on the other hand to the service industry for the management of places where it is desired that there be certain precipitation of water in the form of rain. The invention optimizes the number of nuclei for the formation of water or ice droplets in the clouds where they are applied, also allowing faster and less costly cloud seeding, requiring less volume of seeding dispersion to be handled. The silver iodide dispersion has an ionic solution for cloud seeding, characterized in that the continuous phase, that is, the solvent of the dispersion, is a mixture of at least 1) toluene, with 2) p-xylene. ,3) o-xylene, 4) 2-butoxyethanol and 5) methylcyclohexane.

### FIELD OF THE INVENTION

The present invention is related to the chemical products industry on the one hand and on the other hand to the service industry for climate modification, for the stimulation of rain through the technique known as cloud seeding with the purpose of improving efficiency of precipitation and induce rain in geographical areas of interest.

### BACKGROUND OF THE INVENTION

Until now, in the state of the art, there have been multiple processes for manufacturing substances to stimulate the precipitation of moisture contained in air formations called clouds.

The lack of knowledge of the physical chemistry of clouds has led to the development of ineffective methods and devices to extract water from clouds. Thinking that clouds are water in the form of vapor, without knowing how that vapor is found, has made some inventions not work. For example, an air cooler to condense water vapor and bring that water to the earth's surface.

Nimbus stratus or nimbus cumulus clouds are those that produce rain, snow, sleet, or hail. Because nimbus clouds are dense and contain water, they appear darker than other clouds. Nimbus clouds form at low altitudes and are generally evenly distributed across the sky.

The U.S. Patent Office has granted patents related to rain formation and induction propagation for nearly the past 100 years. In 1920, the U.S. Pat. No. 1,338,343 was granted for the process and apparatus to produce intense artificial clouds, fogs, or mists. In this invention, the atomization of an anhydrous chloride, such as tin chloride or titanium chloride, is used.

Cloud seeding has been practiced for many years around the world. Scientific papers have reported on cloud seeding experiences in the US, Israel, China, South Africa, Argentina, and other countries, as noted below. In general, cloud seeding successes have been documented as statistical differences in the probability of rainfall, rather than direct measurements of cause and effect.

Cloud seeding is now considered a potentially very valuable tool for improving rainfall precipitation. Research progress has produced encouraging results that will eventually make cloud seeding a practical technique to overcome drafts through programmable rainfall induction and develop water supply for many regions. Although the effectiveness of cloud seeding is currently a topic of academic debate, many countries have put significant resources and efforts into direct cloud seeding. Regardless of whether there are yet no reports of a proven or reproducible direct cause effect of cloud seeding and precipitation, claims of successful correlations reinforce international efforts.

The seeder-feeder mechanism is a unique and well-characterized rain induction process where the relevance of the present invention is significant. The seeder-feeder mechanism typically occurs when a double layer of clouds, one on top of the other, leaves a gap of approximately 500 m to 1500 m of air.

The seeder-feeder mechanism is defined as the introduction of ice or condensed water nuclei from above into a lower-level liquid cloud. The introduction of condensation nuclei can initiate precipitation from the low-level cloud layer. As condensation nuclei enter the lower liquid cloud, ice crystals or condensates can grow by deposition, which can cause precipitation of the lower cloud. There are features in the observed soundings and surface observations that can alert a forecaster to the possibility of the seeder-feeder process occurring within 12 hours.

In a type of seeder-feeder cloud system, nuclei may form in the upper cloud and may be produced around airborne dust particles made of kaolinite/clay, ash/volcanic dust, or vermiculite. Nuclei may also be formed by artificially dispersed silver iodide, potassium chloride, simple salt, or other compounds. Properly dispersed particles in the micro- and nanoscale ranges can efficiently seed cloud cores using as little as 500 g per square kilometer.

Precipitation resulting from a seeder-feeder mechanism is highly dependent on the proper characterization of all atmospheric parameters as well as spatial variables such as the thickness of the upper and lower clouds and the intervening air space. The distributions of temperature, pressure, wind, and humidity within the clouds, in the air space, as well as the corresponding surface variables.

Furthermore, a variable that has also been noted in the many experiences with cloud seeding is the agent that is seeded. Both its chemical composition and its physicochemical form of application.

State-of-the-art rainfall induction technologies typically involve poor decision-making based on long-distance, low-precision measurements of atmospheric parameters, low-precision procedures, and crude and/or unsafe seeder dispersal practices.

For example, China has practiced rain induction (or hail prevention) by launching ground-to-cloud rockets. The explosive charges were delivered using missiles to disperse the seeding materials, where decision-making was also made from long-distance measurements from the ground to the clouds, or simply from visual appreciations such as the morphology of the clouds with the help of atmospheric parameters on the ground.

Other approaches involve airplane flights into the clouds, or the dispersal of smaller particles floating from ground stations into the clouds.

At least some known efforts to counteract the effects of water scarcity and drought have focused on climate modification techniques, such as cloud seeding and cloud ionization. Cloud seeding involves injecting silver iodide particles or other suitable substances from an aircraft into the atmosphere, allowing moisture to accumulate on the particles, freeze, and fall to the ground as water. However, cloud seeding is generally expensive, and its effectiveness is limited by the supply of particles and the flight time of the aircraft that injects the particles into the atmosphere. Cloud ionization involves radio frequency antennas that emit negatively charged ions into the atmosphere. In theory, negatively charged ions will increase the probability that supercooled moisture droplets will collide with a frozen core, thus turning into rain. However, the effectiveness of terrestrial cloud ionization is debatable. J. Warner & S. Twomey in 1956 published The Use of Silver Iodide for Seeding Individual Clouds, Tellus, 8:4, 453-459, DOI: 10.3402/tellusa.v8i4.9037, which describes the seeding of supercooled clouds (cryogenic seeding), whose temperatures are below −5° C., with a solution of silver iodide in acetone, in which the silver iodide is used as a nucleus to the formation of ice crystals. This suspension is found in a concentration that can be 100 or 200 g/L (10 g of AgI in 50 or 100 cc of acetone) and is released in the form of smoke by airplanes flying through the upper levels of the cloud or just below the cloud base.

It is important to note that AgI has a solubility of 3×10⁻⁷ g/100 mL (20° C.), that is, practically insoluble in water and Acetone.

From the reported experiments it seems clear that silver iodide is an effective agent for inducing precipitation in supercooled clouds whose temperatures are below −5° C. The time required to release precipitation is usually about 20 to 25 minutes after of seeding in the case of a cumulus cloud but may be longer in the case of elusive layers. The question of whether precipitation will reach the ground clearly depends on the amount released, the height of the cloud base above the ground, and the dryness of the air between them. In most cases, however, any reasonably deep clouds that were seeded produced rain that reached the ground. It is interesting to note that these conclusions are very similar to those of SQUIRES and SMITH (1949) regarding the effect of seeding supercooled clouds with dry ice.

Silver iodide is considered by far the most effective substance for the nucleation of ice crystals in supercooled clouds, thanks to its insolubility, which causes the crystals to remain undistorted in their solid state, and because the shape of the Crystalline lattice is very similar to that of ice, in such a way that it functions as a mold that induces the formation of supercooled water crystals on the exposed face of the crystal. However, various modern studies indicate that it is not as efficient and that it is not possible to explain this cryogenic capacity with only the similarity between the crystalline structures.

On Jan. 29, 1974, a patent application was published, with a priority filed on Sep. 4, 1972 in the USA, to protect an invention of AMAND P; KOFF I, with the title “UNIFORM SIZE PARTICLE GENERATOR”, where a method and apparatus for the generation of fine particles, for example, silver iodide, from a nebulizer for cloud seeding are described. The nebulizer consists of a large container in which a constant level of a combustible or highly volatile solution, such as a solution of silver iodide in acetone, is maintained. An ultrasonic generator at the base of the container produces micrometer-sized droplets of the solution in the air space above the solution. The droplets are expelled from the container by a stream of solvent-laden air toward a burner or vent that burns the solvent. However, the formation of nucleation sites, regardless of the particle size that is added to the suspension with acetone, is generated from the sublimation of silver iodide by burning said suspension, then these vapors condense and form the crystallization nuclei. The number of nucleation sites is determined in a device called a Cloud Chamber, in which, indirectly, the number of nuclei generated in the AgI aerosol at different temperatures is determined, resulting in quantities between 108 and 1011 Nuclei/liter of product. The more crystallization nuclei that can be introduced into the cloud, the probability of inducing an increase in precipitation or of inducing precipitation when the number of nuclei naturally present in the aerosol in the atmosphere is insufficient to break the colloidal stability that gives as a result, a precipitation efficiency of zero will be higher.

In document CA850537 A by POWER, B., published on Sep. 1, 1970, the seeding of clouds with silver iodide to nuclear ice is described. For this, an aqueous dispersion of silver iodide and a substance to keep the silver iodide in dispersion is atomized and distributed in a cold atmosphere susceptible to precipitation to form fine droplets that act as nuclei for precipitation. The solubilizing substance is preferably a co-solute of which water-soluble iodides including sodium iodide, potassium iodide or ammonium iodide are preferred, or which may be sodium chloride. The solution used is an aqueous solution containing 30-92% (preferably 80-90%) saturation of AgI, which has a concentration of 145 g/L (14.5 g of AgI in 100 cc of solvent KI, NaI, NH4Cl or NaCl), however there are no records of its commercial application in cloud seeding operations, which can be explained because what is needed to break the colloidal equilibrium of the hydrometeors of a cloud for a precipitation to occur, as is the case of the tiny droplets of supercooled water in the upper parts of the clouds, are surfaces on which the formation of ice crystals can be induced, or in the case of the tiny droplets of water at a temperature above the freezing point in the middle or lower parts of a cloud, particles are required that form drops that can grow by overcoming the Kelvin Effect and, if they are soluble in water, take advantage of colligative properties to obtain droplets of a size that, when broken, generate new droplet growth points through the collision-coalescence process that give rise to droplets of a size that allows them to precipitate, the introduction of solubilized silver iodide could not generate any of these effects.

From the analysis of the state of the art of the use of silver iodide for cloud seeding, there are still aspects of said use that have not been fully studied for optimal use of the seeding agent.

The more active nuclei for the formation of water droplets (hygroscopic seeding) or ice (cryogenic seeding), the better use of silver iodide will be. Thinking about having a particle reduction device such as a mill or an atomizer, or an ultrasonic generator, or even a burner, has some drawbacks that opened the opportunity to develop what is proposed in this patent to facilitate the application of the product, have a way to generate the nucleation points by a method other than sublimation, which does not involve the risks of handling flammable substances or pyrotechnic material in aircraft that are used for their dispersion in the clouds, and on the other hand, generate these nuclei of crystallization that generate more efficient active surfaces for the technique known as cryogenic seeding and that at the same time allows it to behave as a condensation nucleus with high effectiveness to be applied in the technique known as hygroscopic seeding in cloud areas that contain liquid water at temperatures above 0° C.

Most AgI aerosols used operationally for weather modification are produced by sublimation via the combustion of silver iodide solutions in acetone or pyrotechnic generation methods (DeMott, 1995). Atomized AgI-acetone solutions are usually burned in a propane flame. During subsequent cooling in the atmosphere, aerosol particles are formed. Currently, instead of pure AgI, mixtures, such as AgI, AgCl and paradichlorobenzene, are used to produce particles with improved ice nucleation capacity compared to AgI alone (probably due to improved wetting ability by generating modified surfaces more like water). The optimal sublimation temperature for silver iodide was found to be 1023 K. The optimal suspension concentration in acetone was determined to be 2 wt % (Shevkunov, 2005).

However, the advance of science applied to the generation of aerosols based on AgI, the average effectiveness of cloud seeding operations using these sublimation techniques through the combustion of solutions in acetone or through pyrotechnic compounds, is still questionable.

The use of AgI in colloidal solution increases the number of condensations nuclei but modifies the thermal effect of the crystals of this substance.

### SUMMARY OF THE INVENTION

One of the aspects of the present invention is to achieve a cloud seeding agent that optimizes the number and/or effectiveness of condensation nuclei, ice formation nuclei of the clouds where they are applied.

Another aspect is to reduce the complexity of applying cloud seeding, making it faster and less expensive, requiring less volume of seeding dispersion to be handled and reducing the risk of handling combustible, explosive or pyrotechnic materials in the operation of the aircraft used for cloud seeding.

Still another aspect of the present invention is the application of a mixture of solvents and organic substances that achieve the synthesis of a miscellar dispersion of silver iodide with ultrafine particle size, that is, nanometric size, which allows us to generate crystallization nuclei or highly effective condensation nuclei by spraying micrometric droplets, in liquid and cold, in susceptible cloud regions.

Still another aspect of the present invention is to increase the number of condensation nuclei, without losing the cryogenic effect of the seeding agent.

And all those aspects and advantages that will become evident upon reading this description and the examples that are added for illustrative, but not limiting, purposes.

### DETAILED DESCRIPTION OF THE INVENTION

One embodiment of the present invention consists of a true dissolution of AgI (silver iodide) in a solvent or a mixture of organic solvents. Any organic solvent that achieves ionic dissolution of the iodide can be used.

With the particle size being equal to the silver iodide ion, this would be the smallest possible particle size, and this would mean that a true solution of silver iodide with a concentration of 400 ppm (0.4 g/l, would generate 1.7×1020 condensation nuclei, where the dispersing phase is a mixture of organic solvents derived from petroleum.

Although the previous concentration is the maximum concentration, it is possible to make solutions of lower concentration depending on the sowing objectives.

Achieving a homogeneous and stable dispersion of silver iodide is an important achievement, however, obtaining this dispersion at the nanometric solution level, which allows generating aerosols with crystallization nuclei and/or cloud condensation nuclei, through its Spraying in liquid and cold form, using micrometric drops, to induce an increase in precipitation efficiency through cloud seeding techniques, is a novel and disruptive proposal.

On the other hand, achieving a silver iodide product in solution means that the volume that is required to be handled is small, to achieve the same effect as if a suspension or even a colloid were handled. The number of silver iodide nuclei, when a nanometric solution is achieved, is only restricted by the amount that the continuous phase can dissolve, even before reaching saturation.

It is simpler to reduce the particle size of silver iodide through a dissolution process than through grinding. The same for the step of incorporating silver iodide into the cloud to be seeded. Having a nanometric solution, its application will not depend on expensive seeding processes, such as the combustion of the disperse, or the need for an ultrasonic generator. Silver iodide has a solubility in water of 3×10⁻⁷ g/100 mL at a temperature of 20° C., meaning that silver iodide is practically insoluble in water. The same thing happens with its solubility in acetone.

During the development process of the present invention, it was observed that silver iodide is not soluble in an aqueous solution of ammonia.

The cryogenic effect of silver iodide cannot be explained simply by the similarity of its crystalline structure with that of ice; it is necessary to create crystallization nuclei that have active surfaces similar to water so that the formation of ice crystals is induced by the immersion or guaguagua processes, and those generated through sublimation processes are not very effective even when heterogeneous complexes of silver iodide with chlorine and sodium have been achieved, for example, and in many cases these nuclei formed by sublimation are susceptible to contamination with some gases present in the atmosphere and reduce their effectiveness. The nuclei generated by the organo-metallic complex generated by the invention result in active surfaces that do not present this disadvantage.

Working on solvents for silver iodide and starting from the fact that it was not soluble in acetone, as in the case of aqua regia, the combination of different solvents and organic substances was tested, arriving at the conclusion that a combination of toluene, whose synonym is ethylbenzene, with p-xylene, o-xylene and 2-butoxyethanol, and ethyl derivatives, the solubility of silver iodide was obtained.

With this combination of solvents and organic substances, a miscellar dispersion of silver iodide of 400 ppm could be achieved, which is equivalent to a concentration of 400 mg of silver iodide/liter of solution.

The atomic weight of iodine is 126.90 g, that of silver is 107.87 g. The molecular weight of silver iodide is 234.77 g, therefore, it can be said that one mole of silver iodide weighs 234.77 g.

If one mole weighs 234.77 g, 400 mg of silver iodide, how many moles is it? 400 mg is equal to 0.4 g and is equivalent to 1.70×10⁻³ moles, and according to Avogadro's number, one mole of any substance has 6.023.

(1.70×10−3)×(6.023×1023)=1.023×1020AgI molecules/liter

It has been verified that the crystals are not uni-molecular, we estimate that they are between 49 and 120 molecules per nanocrystal, so the number of nuclei generated is of the order of 1×1018 and 2×1018 nuclei/liter.

In the case of the cryogenic seeding technique, to introduce the same amount of nucleation centers in the clouds, with the products of the state of the art, through sublimation, it would be necessary to use a greater amount of silver iodide to obtain similar results.

So, with respect to the product aspect of the present invention, we have that our invention consists of a dispersion of 400 mg of silver iodide, in one liter of a combination of 1) toluene, with 2) p-xylene, 3) o-xylene, 4) 2-butoxyethanol and 5) methylcyclohexane. This would be the qualitative composition.

As a quantitative composition we will define that toluene can vary between 16.4 and 97.9%, and that p-xylene varies between 0.7 and 50%, with respect to the final solution. O-xylene, for its part, can be present in an amount between 1.9 and 7.7%. The effect between these two quantities was measured and a similar effect was obtained.

Butoxyethanol can be present between 2.7 and 9.9% and methylcyclohexane varies between 0.8 and 9.8%.

A mixture of 16.4% toluene, 50% p-xylene, 7.7%, 9.9% 2-butoxyethanol was made, making the first solvent composition A.

A mixture of 97.9% toluene, 0.7% p-xylene, 1.4% o-xylene was prepared to make the second solvent composition B.

A mixture of 57% toluene, 25.35% p-xylene, 5% o-xylene, 9.9% 2-butoxyethanol 2.75 methylcyclohexane was prepared. The third solvent composition C was obtained.

Solvent D is an already mixed product that is the result of the fractional distillation of petroleum, known as thinner. In addition to there being several types of these, being a natural product, its composition is very varied, qualitatively, and quantitatively.

### EXAMPLES

### Example 1

Solvent composition A was taken, and 400 mg of silver iodide was added, an organic solution was obtained, resulting in a completely transparent solution.

### Example 2

Solvent composition B was taken, and 400 mg of silver iodide was added, an organic solution was obtained, resulting in a completely transparent solution.

### Example 3

Solvent composition C was taken, and 400 mg of silver iodide was added, an organic solution was obtained, resulting in a completely transparent solution.

### Example 4

Solvent composition D was taken, and 400 mg of silver iodide was added, an organic solution was obtained, resulting in a completely transparent solution.

These compositions allow maintaining the nano-crystal structure of silver iodide, with all the advantages that this entails.

And in the aspect of its application, several functional methods were tested, 1) the product is sprayed in the cloud using a device that sprays it cold, using a pump and a spray or 2) using an air tank. under pressure and a spray.

The means that allow the product to be sprayed to be uploaded to the cloud are already state-of-the-art. drones, airplanes, helicopters, aerostat balloons, among others, have been used.

1. A composition for cloud seeding comprising: a dispersion of silver iodide in a solvent or mixture of organic solvents.

2. The composition according to claim 1, wherein the dispersion is a nanometric organic solution, where the silver iodide is in the form of nanocrystals of about 49 molecules each.

3. The composition according to claim 1, wherein said mixture of organic solvents comprises of at least toluene, with p-xylene, o-xylene, 2-butoxyethanol and methylcyclohexane.

4. The composition according to claim 3, wherein said toluene is present between 16.4 and 97.9%, and p-xylene varies between 0.7 and 50%, with respect to the final solution.

5. The composition according to claim 3, wherein said o-xylene is present in an amount between 1.9 and 7.7%%, with respect to the final solution.

6. The composition according to claim 3, wherein said 2-butoxyethanol is present between 2.7 and 9.9% and methylcyclohexane varies between 0.8 and 9.8%.

7. The composition according to claim 1, wherein the dispersing consists of thinner.

8. The composition according to claim 1, wherein the silver iodide is present in an amount of 400 mg/L.
